(19) United States
(12) Patent Application Publication
(10) Pub. No.: US 2018/0062988 A1
(43) Pub. Date: Mar. 1, 2018

(54) ETHERNET COMMUNICATION OF CAN SIGNALS

(71) Applicant: Faraday&Future Inc., Gardena, CA (US)

(72) Inventors: Mayank Sikaria, Folsom, CA (US); Douglas D. Chidester, San Pedro, CA (US); Caio D. Gubel, San Clemente, CA (US)

(21) Appl. No.: 15/253,610

(22) Filed: Aug. 31, 2016

(51) Int. Cl. H04L 12/721; H04L 29/08

(52) U.S. Cl. CPC H04L 45/66; H04L 12/40; H04L 67/12

(57) ABSTRACT

A vehicle can use controlled area network (CAN) buses for communications within a subsystem but connect different subsystems using Ethernet connections. For example, a network interface (NIC) of a subsystem can receive a CAN message from a CAN bus and incorporate the CAN message into a user diagram protocol (UDP) message which can be then packaged into an Ethernet packet. The UDP message may include a table of contents (TOC). The TOC may include the message ID and the length of the CAN message. Once a NIC receives the message, the receiving NIC can extract the UDP message from the Ethernet packet, parse through the TOC to identify a CAN message relevant to the control units of the receiving NIC's subsystem, extract the relevant CAN message based on the TOC, and put the CAN message onto CAN buses to be sent to destination CAN devices.

### FIELD

This disclosure relates generally to the field of automotive technology, and more particularly to systems and methods for communications of messages across multiple vehicle subsystems.

### BACKGROUND

A controller area network (CAN) is frequently used for communication between various vehicle systems within a vehicle, such as electronic control units (ECUs). Each device connected with the CAN bus generally is able to transmit data onto the CAN bus and receives data that has been transmitted on the CAN bus by other connected devices.

### SUMMARY

In some embodiment, a vehicle can comprise a plurality of vehicle operating subsystems. The vehicle can also comprise a first plurality of electronic control units (ECUs) communicatively coupled to a first network communication bus associated with a first subset of the plurality of vehicle operating subsystems, wherein the first plurality of ECUs is configured to communicate over the first network communication bus with messages formatted according to a first network protocol, and a second plurality of ECUs communicatively coupled to a second network communication bus associated with a second subset of the plurality of vehicle operating subsystems, wherein the second plurality of ECUs is configured to communicate over the second network communication bus with messages formatted according to the first network protocol. The vehicle can further comprise a first network interface communicatively coupled to the first network communication bus and a second network interface communicatively coupled to the second network communication bus. The first network interface and the second network interface can be communicatively coupled to a third network communication bus, wherein the first network interface and the second network interface can be configured to communicate over the third network communication bus with messages formatted according to a second network protocol. The first network interface can be configured to receive first messages from the first plurality of ECUs via the first network communication bus, incorporate the first messages into a packet formatted according to the second network protocol, and send the packet to the plurality of vehicle operating subsystems. The second network interface can be configured to receive the packet from the third network communication bus, parse the packet to extract second messages with addresses associated with the second plurality of ECUs, reformat the second messages according to the first network protocol, and deliver the second messages to the second plurality of ECUs via the second network communication bus.

In some implementations, a method for communication among a plurality of vehicle operating subsystems is disclosed. The method comprises establishing first communications among a first plurality of ECUs in a vehicle and between the first plurality of ECUs and a first network interface, wherein the first communications are via a first network communication bus associated with a first subset of the plurality of vehicle operating subsystems and the first plurality of ECUs communicates over the first network communication bus with messages formatted according to a first network protocol. The method can also establish second communications among a second plurality of ECUs in the vehicle and between the second plurality of ECUs and a second network interface, wherein the second communications are via a second network communication bus associated with a second subset of the plurality of vehicle operating subsystems and the second plurality of ECUs communicates over the second network communication bus with messages formatted according to the first network protocol. The method can further establish third communications between a first network interface and a second network interface via a third network communication bus with messages formatted according to a second network protocol; receiving, by the first network interface, first messages from the first plurality of ECUs via the first network communication bus. The method can incorporate, by the first network interface, the first messages into a packet formatted according to the second network protocol and sending, by the first network interface, the packet to the plurality of vehicle operating subsystems. The method can also receive, by the second network interface, the packet from the third network communication bus; parse, by the second network interface, the packet to extract second messages with addresses associated with the second plurality of ECUs; reformat by the second network interface, the second messages according to the first network protocol; and deliver, by the second network interface, the second messages to the second plurality of ECUs via the second network communication bus.

Details of one or more implementations of the subject matter described in this specification are set forth in the accompanying drawings and the description below. Other features, aspects, and advantages will become apparent from the description, the drawings, and the claims. Neither this summary nor the following detailed description purports to define or limit the scope of the inventive subject matter.

### BRIEF DESCRIPTION OF THE DRAWINGS

FIG. 1 is a block diagram depicting a CAN bus and its connections to various vehicle operating subsystems in accordance with an exemplary embodiment.

FIG. 2 is a block diagram depicting a communication network across multiple vehicle operating subsystems in accordance with an exemplary embodiment.

FIG. 3 is a block diagram depicting an embodiment of an in-vehicle network in accordance with an exemplary embodiment.

FIG. 4 is a block diagram depicting example formats of an Ethernet frame, a user datagram protocol (UDP) message, and a CAN message in accordance with an exemplary embodiment.

Throughout the drawings, reference numbers may be re-used to indicate correspondence between referenced elements. The drawings are provided to illustrate example embodiments described herein and are not intended to limit the scope of the disclosure.

### DETAILED DESCRIPTION

### Overview

In automotive communications, CAN buses can be used for communications among multiple vehicle operating subsystems. In some situations, CAN is the required protocol for in-vehicle communications. However, a CAN bus has limited bandwidth and is highly sensitive to disruptive communications, as even random data placed on a CAN bus may cause significant damage to various connected systems. Undesired CAN bus transmissions are capable of causing significant problems for the operation of a vehicle. For example, if a vehicle operating subsystem or a microcontroller of the vehicle operating subsystem is altered to “spam” the CAN bus, or send a large number of unnecessary or meaningless messages through the CAN bus, it may prevent other valid and necessary messages from being transmitted, negatively impacting vehicle performance. Additionally, CAN connections are not secure. A device outside of the vehicle may listen to the CAN communication and potentially alter the communication or spam the CAN buses, causing disruptions of the vehicle's operation. Furthermore, due to the limited bandwidth of a CAN bus, multiple CAN buses may be required for connections between controls units in different vehicle operating subsystems (such as between the vehicle body and the information and entertainment center). This may cause a vehicle to have a large number of burdensome wires for simple communications across multiple subsystems.

To ameliorate these problems, a vehicle can use CAN buses for communications within a subsystem but connect different subsystems using buses configured for Ethernet communication. The vehicle network can be configured to pass the CAN signals in an Ethernet packet for communications across different subsystems. For example, a control unit of a subsystem can generate a CAN signal. The control unit may have a processor which incorporates the CAN signal into a CAN frame to create a CAN message. The control unit can put the CAN message onto a CAN bus. The network interface (NIC) of a vehicle operating subsystem can receive the CAN message from the CAN bus and incorporate the CAN message into a user diagram protocol (UDP) message which is then packaged into an Ethernet packet. The UDP message may include a table of contents (TOC). The TOC may include the message ID and the length of the CAN message.

The NIC can pass the Ethernet message to other NICs in the vehicle via the Ethernet connection. Once a NIC receives the message, the receiving NIC can extract the UDP message from the Ethernet packet. The NIC can parse through the TOC to identify whether the UDP message includes one or more CAN messages relevant to the control units within the receiving NIC's subsystem. The NIC can then extract the relevant CAN messages based on the TOC and put the CAN messages onto CAN buses to be sent to destination CAN devices.

The following description is directed to certain implementations for the purpose of describing the innovative aspects of this disclosure. However, a person having ordinary skill in the art will readily recognize that the teachings herein can be applied in a multitude of different ways. The described implementations may be implemented in conjunction with any communications bus, alone or in combination, for communication between vehicle systems.

### Example Embodiments of a CAN Bus

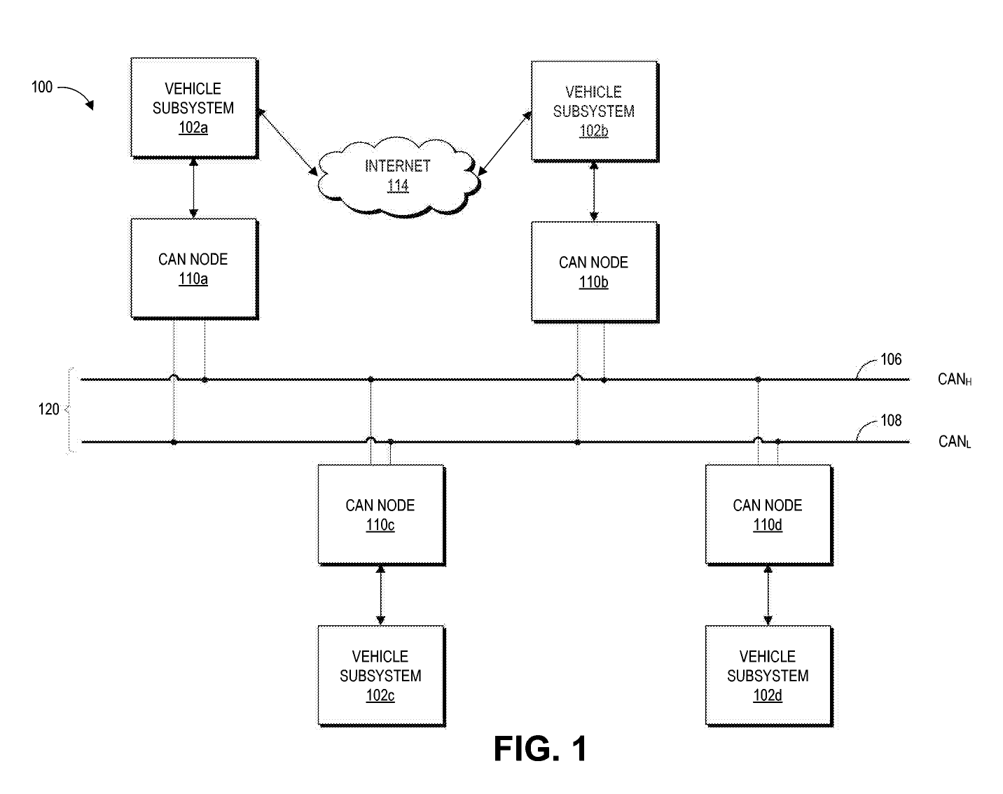

FIG. 1 is a block diagram depicting a CAN bus 120 and its connections to various CAN nodes 110 (such as CAN nodes 110a, 110b, 110c, and 110d) in accordance with an exemplary embodiment. CAN is a communication system for vehicles which allows devices connected to the CAN bus to communicate with each other.

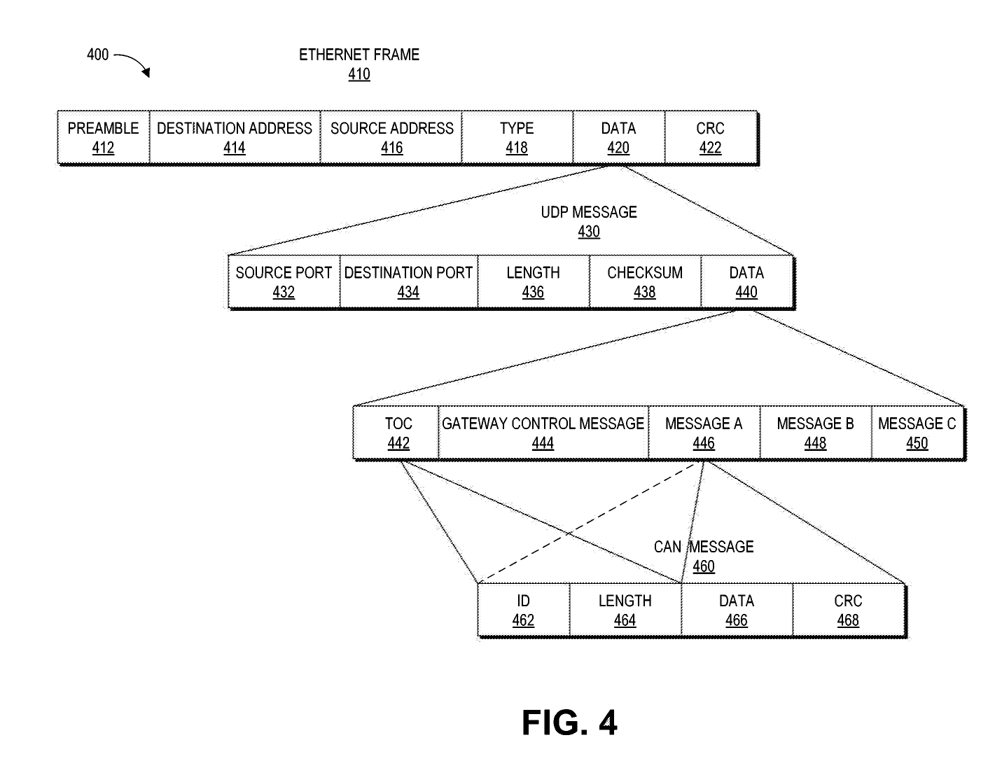

In the network environment 100 of FIG. 1, the CAN nodes 110a, 110b, 110c, and 110d can communicate with each other via a CAN bus 120. A CAN node may have circuitry including a transceiver configured to transmit messages from a vehicle subsystems 102 to the CAN bus 120 and send messages received from the CAN bus 120 to a vehicle system 102. For example, a CAN node may check whether the CAN bus is busy. If the CAN bus is not busy, the CAN node can incorporate a CAN signal into a CAN message (further described in FIG. 4) and send the CAN message onto the CAN bus. Other CAN nodes can listen to the messages on the bus and use the ID of the CAN message to determine whether to accept the CAN message.

A CAN node may be a network interface configured to communicate with other network devices. For example, the CAN node can include a gateway allowing a computer to communicate with a USB connection or an Ethernet port.

The CAN nodes 110 can further be connected to various vehicle subsystems 102 (such as vehicle subsystems 102a, 102b, 102c, and 102d). The vehicle subsystems may include various ECUs such as engine control units and control units for battery, windows, doors, electric power steering, airbags, cruise control, and so on. For example, a CAN node may be a battery powertrain network interface which can be configured to communicate with other systems such as a powertrain system via a CAN bus. The battery powertrain network interface can also communicate, via another CAN bus, with string control units arranged to monitor each battery string and to generate the enable signal for the respective string when appropriate.

In some implementations, one or more CAN nodes may be part of a vehicle subsystem. A CAN node may be part of an electronic control unit (ECU) for controlling one or more sensors or other ECUs. For example, an advanced driver assistance system (ADAS) may include a network interface connected to a parking assist control unit and a stereo vision camera, all of which may be CAN nodes.

The CAN nodes 110 can transmit and receive data among vehicle subsystems 102 via the CAN bus 120. The CAN bus 120 can transmit data between various CAN nodes 110 through differential signaling, using a high-voltage line 106 and a low-voltage line 108 as a differential pair.

Any number of vehicle subsystems 102 may communicate with a CAN bus 120. In some embodiments, an ECU of a vehicle subsystem may communicate directly with another ECU in the same subsystem or in a different subsystem through one or more CAN buses. Some vehicle subsystems 102 (such as vehicle subsystems 102a and 102b) may also be connected to the internet 114. For example, a telematics unit, integrated GPS, navigation system, remote diagnostics system, in-vehicle security system, infotainment system, or any other module of a car involving wireless connectivity or data transmission may be connected to the internet. The vehicle subsystems may connect to the internet 114 or any other network via any one or a combination of protocols such as GSM, GPRS, WLAN, Wi-Fi, Li-Fi, LTE, cellular network, Bluetooth, or the like.

### Example Embodiments of a Communication Network Across Multiple Vehicle Operating Subsystems

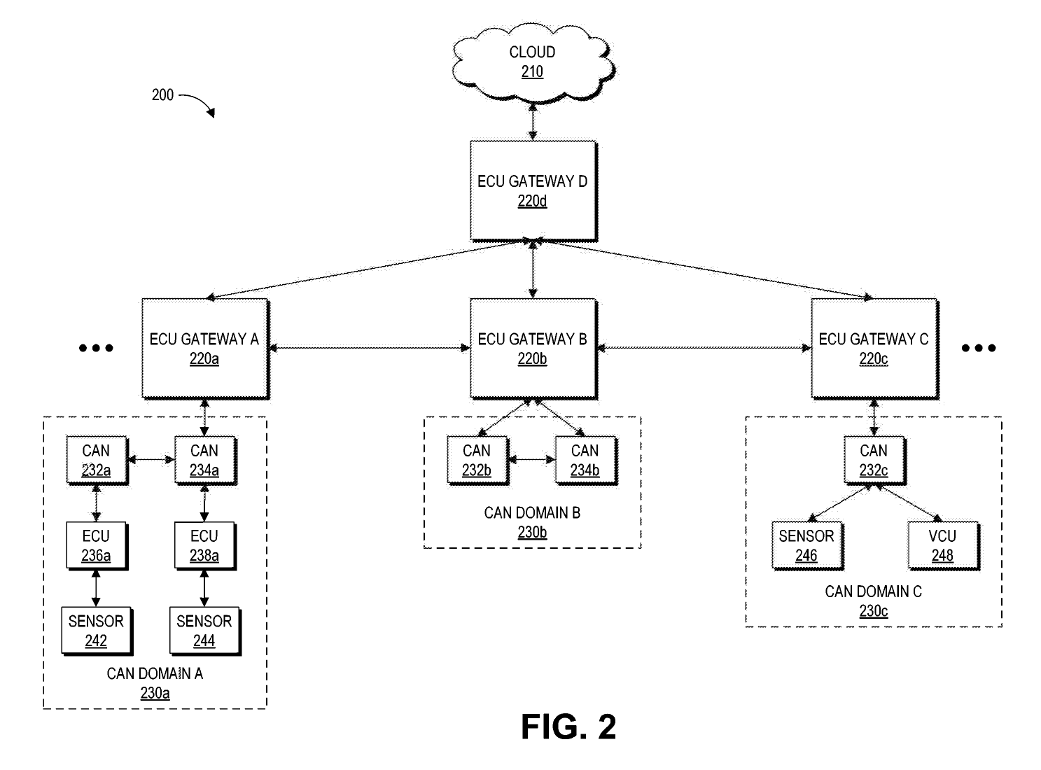

FIG. 2 is a block diagram depicting a communication network across multiple vehicle operating subsystems in accordance with an exemplary embodiment.

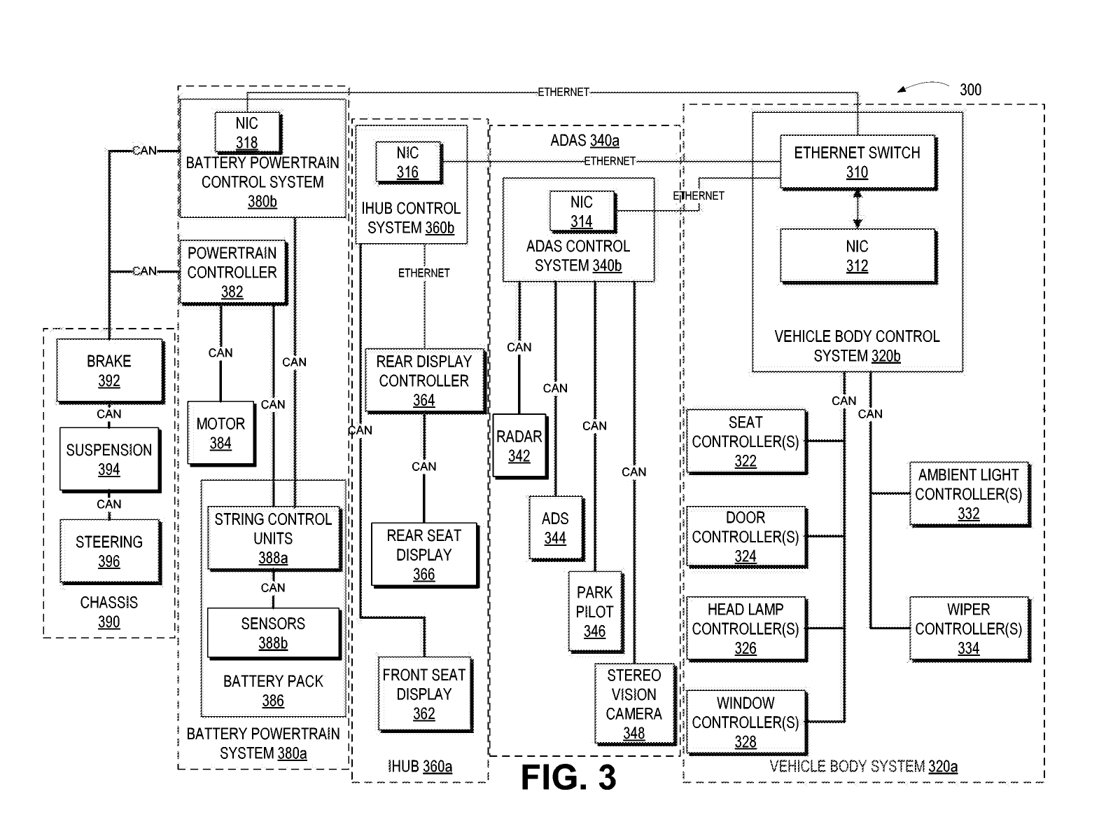

In the network 200, the ECU gateways 220 can connect with each other via an Ethernet connection. The ECU gateways 220 (e.g., 220a, 220b, 220c, and 220d) may be embodiments of the CAN nodes 110 as described with reference to FIG. 1 and/or embodiments of the NICs (e.g. 312, 314, 316, and 318) in FIG. 3. These ECU gateways can communicate with each other using UDP messages, although other protocols may also be used.

One or more ECU gateways can also communicate with computer systems outside of the vehicle. For example, the ECU gateway D 220d can communicate with cloud computing devices 210 such as Bluetooth, radio, and so on. The ECU gateway D 220d can further pass the information from the cloud computing devices 210 to other ECU gateways 220a, 220b, and 220c, and vice versa.

An ECU gateway may be in communication with a CAN domain. For example, the ECU gateway A 220a can communicate with the CAN domain A 230a. The ECU gateway B 220b can communicate with the CAN domain B 230b. The ECU gateway C 220c can communicate with the CAN domain 230c. The communication between the ECU gateway and the CAN domain may be via a CAN bus, although other types of network configurations such as an Ethernet communication may also be used.

A CAN domain may be a vehicle operating subsystem or a portion of a vehicle operating subsystem. The CAN domain may include multiple CAN devices such as CAN nodes, sensors, or ECUs, alone or in combination. Within the CAN domain, the CAN devices can communicate with each other by sending and receiving CAN signals via one or more CAN buses. As an example, the CAN domain A 230a may include CAN devices such as CAN nodes (232a and 234a), ECUs (236a and 238a), and the sensors (242 and 244). The sensors 242 and 244 may be controlled by the ECUs 236a and 238a, respectively. These CAN devices can communicate with each other via a CAN bus. For example, the CAN node 234a may receive a signal for opening left and right doors of a vehicle. The CAN node 234a can pass the signal to the sensor 242 via the CAN node 232a and ECU 236a. The CAN node 234a can also pass the signal to the sensor 244 via the ECU 238a. After receiving the signals, the sensors 242 and 244 can open the left and the right doors, respectively.

As another example, the CAN devices 232b and 234b can communicate directly with each other via a CAN bus in CAN domain B. In this example, the CAN devices 232b and 234b may be ECUs. The CAN devices 232b and 234b can also send and receive messages with the ECU gateway B 220b, via for example, CAN signals.

As a further example, the CAN domain C 230c includes a CAN node 232c, a sensor 246, and a vehicle control unit (VCU) 248. The vehicle control unit may be an embodiment of an ECU described herein. In this example, the VCU 248 can control the sensor 246 via the CAN node 242c. For example, the VCU 248 can send an instruction in CAN signal to the sensor 246 via the CAN node 232c. The VCU 248 can also receive a feedback signal from the sensor 246 through the CAN node 232c.

If a CAN device needs to communicate with other CAN domains, the CAN device can pass the CAN signal to an ECU gateway which can package the CAN signal along with other CAN signals into a UDP message. The UDP message may be communicated to other CAN domains in a single-cast, multi-cast, or broadcast mode. The ECU gateway associated with the destination CAN device can pick up the UDP packet and parse through the UDP packet to identify the message addressed to the CAN devices in its CAN domain and send the message to the CAN devices.

As an example, the VCU 248 may need to send an instruction (including a CAN signal) to the sensor 244. Because the VCU 248 and the sensor 244 are in different CAN domains, the VCU 248 can first communicate a CAN message including the CAN signal via a CAN bus to the CAN node 232, which then communicates the instruction to the ECU gateway C 220c. The ECU gateway C 220c can package the CAN message received from the CAN node 232c into a message in the UDP format and incorporate this UDP message into an Ethernet packet. The ECU gateway C 220c can send the Ethernet packet out using one of the single-cast, multi-cast, or the broadcast mode. For example, the ECU gateway C 220c can use the address of the ECU gateway A 220a and send the message directly to the ECU gateway A 220a via the single-cast mode. The ECU gateway C 220c can also address the packet to multiple ECU gateways by, for example, multi-casting to ECU gateway A 220a and the ECU gateway B 220b, or by broadcasting to the entire network. In these circumstances, the ECU gateway A 220a can listen for the Ethernet packets and identify UDP messages needed by its CAN domain 230a from the Ethernet packets. Once the ECU gateway A 220a receives the UDP message from the VCU 248, the ECU gateway A 220a can reformat the message from the UDP protocol to a CAN message and deliver the CAN message to the sensor 244 via the CAN bus.

In some implementations, the UDP messages may also contain ECU gateway control messages directed at controlling one or more ECU gateways. For example, a UDP message may include a software reset and update message. This message may be broadcasted to the ECU gateways on the network and cause the ECU gateways to reset and update.

Example Embodiments of an in-Vehicle Communication Network

FIG. 3 is a block diagram depicting an embodiment of an in-vehicle communication network in accordance with an exemplary embodiment. In the network 300 depicted in FIG. 3, various vehicle operating subsystems, such as the vehicle body control system 320, the ADAS system 340, the information and entertainment hub 360, and the battery powertrain control system 380, can communicate with each other using Ethernet packets. Within each vehicle operating subsystem, the communications may be through CAN messages, Ethernet packets, or other protocols, alone or in combination. Further details of these vehicle operating subsystems and communications between and within these subsystems are described below.

### Examples of Vehicle Operating Subsystems

As shown in FIG. 3, the network 300 includes various vehicle operating subsystems such as a vehicle body control system 320, an advanced driver assistance system (ADAS) 340, an information and entertainment hub (IHUB) 360, a battery and powertrain system 380, and a chassis system 390. These vehicle operating subsystems may be an embodiment of; may include a portion of; or may be a part of the CAN domains 220 (e.g., 220a, 220b, 200c, or 220d) described with reference to FIG. 2.

The vehicle operating subsystems can include one or more CAN devices described with reference to FIG. 2. For example, the vehicle body system 320a may include CAN devices such as seat controllers 322 for adjusting vehicle seats, door controllers 324 for opening and closing the vehicle doors, head lamp controllers 326 for controlling the functions of the head lamps (such as adjusting the brightness of the head lamps or turning the head lamps on or off), and window controllers 328 for rolling windows up and down. The vehicle body system 320a can further include ambient light controllers 332 for adjusting vehicle's interior lighting and wiper controllers 334 for adjusting the speed or the mode of the windshield wipers.

As another example, the ADAS 340a can include CAN devices such as a radar 342 which can acquire information on the vehicle's surroundings, an advanced driving system 344 for automatically driving the vehicle, a park pilot 346 for automatically parking the vehicle, and a stereo vision camera 348 for acquiring and presenting visual images around the vehicle (such as front, rear, and the two sides of the vehicle).

The IHUB 360a can include a front seat display 362 for displaying menus, playing videos, and presenting GPS navigation routes, and so on. The IHUB 360a can further include a rear display controller 364. The rear display controller 364 can control one or more rear seat display 366 for displaying vehicle information such as speed, route, and so on, as well as entertainment information such as movies, video games, etc.

As a further example, the battery powertrain system 380a can include CAN devices such as a powertrain controller 382 which can control the mechanical operations of the vehicle. For example, the powertrain controller 382 can control the motor 384 and various units in the chassis system 390 (such as the brake 392, the suspension 394, and the steering 396). The powertrain controller 382 can also communicate with the battery pack 386 for supplying electricity to other parts of the vehicle as well as for providing indications on how much battery is remaining.

A vehicle operating subsystem may be part of another vehicle operating subsystem. For example, the battery pack 386 may be part of the battery powertrain system 380a. Additionally, the various CAN devices and vehicle operating subsystems shown in FIG. 3 are not an exhaustive list of all network components. A vehicle may include more or fewer CAN devices and vehicle operating subsystem as shown in FIG. 3.

Example Communications within a Vehicle Operating Subsystem

Within a vehicle operating subsystem, the CAN devices may communicate with each other via CAN buses. As described with reference to FIG. 1, a CAN device can generate a CAN signal and incorporate the CAN signal into a CAN message frame. An example CAN message is described in FIG. 4.

A CAN message may be associated with an arbitration identifier (ID) which represents the priority of the CAN message. The arbitration ID may be assigned based on the deadline of the message, where a low arbitration ID may represent a high priority. The arbitration ID is typically unique on a given CAN bus. For example, the arbitration ID for each message transmitted on the CAN bus connecting seat controllers 322, door controllers 324, head lamp controllers 326, and window controllers 328 is typically unique. However, the arbitration ID of a message transmitted on the CAN bus associated with the vehicle body control system may be the same as the arbitration ID of a message transmitted on the CAN bus connecting the radar 342 and other CAN devices of the ADAS 340. This is because the CAN devices within the ADAS 340 are in a separate CAN network than the CAN devices in the vehicle body control system 320.

If the CAN bus is not busy, the CAN device can pass the CAN message onto the CAN bus. But if multiple CAN devices try to transmit messages onto the CAN bus, the CAN device with the highest priority can first access the CAN bus. Lower-priority CAN devices must wait until the bus becomes available before trying to transmit again.

All CAN devices on a CAN network can listen to the CAN messages. Each CAN device (including the sending device) on the network can decide whether to accept the CAN message based on the arbitration ID of the transmitted messages.

A vehicle can include assorted CAN network topologies. For example, in the vehicle body system 320a, multiple CAN devices (such as the seat controllers 322, the door controllers 324, the head lamp controllers 326, and the window controllers 328) may be connected to the same CAN bus. In the ADAS 340a, however, the CAN devices may not share the same CAN bus. For example, the radar 342 and the ADS 344 may use different CAN buses in communication with the ADAS control system 340b.

A CAN device may also be connected to multiple CAN buses. For example, the powertrain controller 382 can connect to the string connect units 388a using a first CAN bus, to the motor 384 using a second CAN bus, and to the chassis system 390 using a third CAN bus. As a result, the powertrain controller 382 may send instructions to the battery pack 386, the motor 384, and the chassis system 390 at the same time using different CAN buses. As another example, the string control units 388a of the battery pack 386 may include a CAN node which interfaces with the sensors 388b and the CAN devices outside of the battery pack 386 subsystem. The string control units 388a can communicate with the powertrain controller 382 and the battery powertrain control system 380 via different CAN buses. The string control units 388a can pass the messages received from the units outside of the battery pack 386 to the sensors 388b or send new CAN messages to the sensors 388b based on the communications with the powertrain controller 382 or the battery powertrain control system 380b.

CAN devices may be arranged on a CAN bus in sequence and/or in parallel. For example, the ambient light controllers 332 and the wiper controllers 334 are arranged in parallel on the same CAN bus. The brake 392, the suspension 394, and the steering 396, however, are arranged sequentially on a CAN bus, where a CAN message from the battery powertrain control system 390 may need to go through the brake 392 (such as a CAN node of the brake 392) before reaching suspension 394. In some implementations, one or more CAN buses between the sequentially arranged CAN devices may be considered as a separate CAN bus. For example the CAN bus between the suspension 394 and the brake 392 may be considered as a different CAN bus than the one connecting the brake 392 and the battery powertrain control system 380. As a result, the arbitration IDs for messages running on the CAN bus connecting the brake 392 and the suspension 394 do not have to be unique in view of the arbitration IDs for messages running on the CAN bus connecting the brake 392 and the battery powertrain control system 380b. In these implementations, the CAN devices may also include a processor which can update the arbitration ID of a received CAN message or generate a new CAN frame for the underlying CAN signal, and pass the updated CAN message onto another CAN bus.

Although the example communications within a vehicle operating subsystem are described with reference to CAN buses and CAN messages, these examples are not intended to be limiting. Other types of communication protocols may also be used for communications within a vehicle operating subsystem. For example, Ethernet protocol may be used for communications between the IHUB control system 360 and the rear display controller 364.

### Example Communications Across Vehicle Operating Subsystems

In FIG. 3, messages may be communicated from a vehicle operating subsystem to another vehicle operating subsystem via an Ethernet connection. A vehicle operating subsystem can have one or more NICs. For example, the vehicle body system 320a can include a NIC 312 in the vehicle body control system 320b, the ADAS 340a can include a NIC 314 in the ADAS control system 340b, and the IHUB system 360a can include a NIC 316 in the IHUB control system 360b. In some implementations, one or more subsystems may be connected to the same NIC. For example, the battery pack 386, the chassis 390, and other units of the battery powertrain system 380a may all be connected to the NIC 318 of the battery powertrain control system 380b. The NICs may be connected to each other via an Ethernet switch, such as the Ethernet switch 310. In certain implementations, one or more NICs may be directly connected by buses configured for Ethernet connections, without going through an Ethernet switch.

A NIC can receive messages from one or more CAN devices via the CAN buses connected to it. As further described with reference to FIG. 4, the NIC can package the received CAN messages inside a UDP message. The NIC can create a TOC in the UDP message, which includes the IDs of the CAN messages as well as the lengths of the respective CAN messages. The NIC can further package the UDP message inside of an Ethernet frame to generate an Ethernet packet. The NIC can send the Ethernet packet to another NIC via a bus configured for communicating Ethernet packets.

As an example, the powertrain controller 382 can generate a CAN signal. The microprocessor of the powertrain controller 382 can incorporate the CAN signal into a CAN frame to create a CAN message. The CAN message can be communicated to the battery powertrain control system 380b via a CAN bus. The NIC 318 of the battery powertrain control system 380b can incorporate the CAN message inside of the UDP message. The NIC 318 can further create a TOC in front of all the CAN messages. The TOC can include a brief overview of the CAN messages such as the message ID as well as the message length. The UDP message can be packaged into an Ethernet frame at the NIC 318.

The NICs can communicate with each other using Ethernet connections. For example, the NIC 318 can communicate the Ethernet packet containing the UDP message to the Ethernet switch 310. The Ethernet switch 310 can route the Ethernet packet to its proper destination based on the address of the Ethernet packet. For example, if the Ethernet packet indicates the receiver is the NIC 312, then the Ethernet switch 310 can pass the Ethernet packet to the NIC 312 of the vehicle body control system 320. However, if the Ethernet packet is broadcasted to the whole network, multiple NICs such as the NICs 312, 314, 316, and 318 may receive the Ethernet packet.

Once a NIC receives the Ethernet packet, the NIC can parse the Ethernet packet and identify one or more UDP messages inside the Ethernet packet. The NIC can parse the TOC of the UDP message and decide whether one or more CAN messages described by the TOC is relevant. For example, the NIC can use the message ID for deciding whether the CAN message is relevant to one or more ECUs associated with the NIC. Once the NIC has decided a CAN message is relevant, the NIC can use the TOC to calculate a starting position of the CAN message inside of the UDP data. Based on the starting position and the size of the CAN message indicated by the TOC, the NIC can extract the CAN message from the UDP data packet.

The NIC can pass the extracted CAN messages to its subsystems via one or more CAN buses. In some embodiments, the NIC may repackage the CAN signal, for example by generating a different arbitration ID for the CAN signal and send the repackaged CAN message on to a CAN bus. Further details regarding packaging, extracting, and passing CAN messages are described with reference to FIG. 4.

Although the examples describe communications among various vehicle subsystems taking place using Ethernet connections, these examples are not limiting. In some implementations, vehicle subsystems can also communicate with each other by passing CAN messages on one or more CAN buses. For example, chassis 390 and the battery powertrain system 380a shown in FIG. 3 may communicate with each other using a CAN bus. Furthermore, although only one Ethernet switch (e.g. Ethernet switch 310) is described in FIG. 3, multiple Ethernet switches may be present in other embodiments of the network. For example, the ADAS control system 340b and the IHUB control system 360b may both include Ethernet switches. Additionally or alternatively, the IHUB 360a can further include a camera system which may include an Ethernet switch and/or multiple Ethernet connections with cameras of the vehicle.

### Example Embodiments of Communicating CAN Messages Over Ethernet

As described above, an ECU of a vehicle operating subsystem can communicate with another ECU in a different vehicle operating subsystem by incorporating the CAN message into an Ethernet packet at a network interface. FIG. 4 is a block diagram depicting example formats of an Ethernet frame, a UDP message, and a CAN message in accordance with an exemplary embodiment.

### Examples of an Ethernet Frame

The data packet 400 may be in the form of an Ethernet packet which includes an Ethernet frame 410. The Ethernet frame 410 can comprise a preamble 412, a destination address 414, a source address 416, a type field 418, data 420, and an error detection code (such as cyclic redundancy check (CRC) 422).

The preamble 412 of the Ethernet frame 410 can include seven bytes of binary starter sequence. For example, the binary start sequences may be: 10101010 10101010 10101010 10101010 10101010 10101010 10101010 10101010. The preamble 412 can allow devices on the network to synchronize their receiver clocks because there is no clock information on the Ethernet when there is no data transmission. The preamble can also include a start frame delimiter which is a single byte indicating the start of the Ethernet frame 410.

The Ethernet frame 410 can include a destination address 414 in the header. The destination address 414 may be the media access control address (MAC address) of the destination device(s), such as the NICs 312, 314, 316, and 318. The destination address 414 is typically 6 bytes although other lengths are possible. For example, the MAC address in older versions of Ethernet may be 2 bytes. The Ethernet packet 400 can be sent in single-cast, multi-cast, or broadcast mode based on the destination address. For example, the most significant bit for a single-cast address may be 0 while the most significant bit for a multi-, cast mode may be 1. As an example, the destination address may consist of all “1”s when the message is for broadcasting throughout the network.

In addition to the destination address 414, the Ethernet frame can also include a source address 416. The source address may be the MAC address of the device sending the message. The source address is typically 6 bytes. With reference to FIG. 3, the source address may be associated with any one of the NICs 312, 314, 316, and 318.

The type field 418 can be used to represent the size of the data 420 of the Ethernet frame 410. Typically the size of the data is between 0 and 1500 bytes although other lengths are possible. This type field 418 can also be used, for example in Ethernet II, to indicate the type of data carried by the frame. For example, it may include a number, such as 080016, indicating an IP data payload.

The data 420 in the Ethernet frame can include messages that the sending device intends to communicate with the destination device(s). The data 420 may include an IP packet which further includes a UDP message 430 as further described below. The IP packet may be an IPv4 or IPv6 packet. In addition to or in alternative to the UDP message 430, the IP packet can also carry a message in a different protocol, such as a transmission control protocol (TCP).

Lastly, the Ethernet frame 410 can include an error detection code. The error detection code may be a frame check sequence which includes a 32-bit CRC 422.

### Examples of a UDP Message

The UDP message 430 can include a header and a data 440. The header may include a source port 432, a destination port 434, a length field 436, and a checksum field 438. The header is typically 8 bytes in total.

The source port 432 is typically 2 bytes and it identifies a port number associated with the sending device. Similarly, the destination port 434 is also typically 2 bytes and it identifies a port number associated with the receiving device. With reference to FIG. 3 the sending device and the receiving device may include the NICs 312, 314, 316, and 318.

The length field 436 is used to specify the length of the UDP message including the UDP header and the UDP data. The length may be expressed in bytes. The minimum length for the length field 436 may be 8 bytes when there is no data, because the UDP header is typically 8 bytes. The maximum length for the length field 436 may vary based on the type of packet carrying the UDP message. For example, in an IPv4 protocol, the maximum length for the length field 436 may be 65,507 bytes. But in an IPv6 protocol, the maximum length may be larger than 65,507 bytes.

The checksum field 438 of the UDP header is used to check errors in the UDP header and the UDP data. This can reduce the likelihood of packet corruption during the course of transportation.

The data field 440 of the UDP message 430 can carry communications from a sending device to a destination device. As described with reference to FIGS. 1, 2, and 3, an ECU of a vehicle operating subsystem may want to control a sensor in another vehicle operating system. The ECU can send a CAN message via a CAN bus to a NIC associated with the vehicle operating subsystem. The NIC can incorporate the CAN message into the data field 440 of the UDP message 430 and communicate the UDP message 430 inside of the Ethernet frame 410 to the NIC associated with the other vehicle operating subsystem.

The data inside of a UDP message 430 can include a TOC 442, a gateway control message 444, and messages generated by various ECUs (e.g., message A 446, message B 448, and message C 450).

The TOC 441 can include pairs of message IDs and lengths, where a pair of message ID 462 and length 464 may be associated with a message. The length of the message included in the TOC may be the size of a CAN message 460 which includes the size of the CAN frame. Additionally or alternatively, the length may be the size CAN signal wrapped in the data field 466 of the CAN message 460. The message identifier of the TOC 442 may be the value in the identifier field 462 of the CAN message 460. The message identifier of the TOC 442 may also be different from the identifier (ID) field 462 or may only be a portion of the identifier field 462. As an example, the ID field 462 may include information that identifies the message and indicates the message's priority. As another example, the TOC 442 may choose to include only the identifying information while ignoring the priority information. The message identifier may be found in a database file, such as vector data base file (.dbc) or by parsing through the CAN frame.

As one example, in FIG. 4, there may be a gateway control message 444 as well as three CAN messages, message A 446, message B 448, and message C 450, in the UDP message 430. The gateway control message may be 3 bytes; the message A 446 may be 2 bytes; the message B 448 may be 8 bytes; and the message C 450 may be 4 bytes. As a result, the entries of the TOC 442 may include: msgControl, 3; msg1, 2; msg2 8; msg3 4. In this example, msgControl, msg, msg2, and msg2 are identifiers uniquely identify their respective messages while the values following these identifies represent the size of the message in bytes. The lengths 3, 2, 8, 4 may be the lengths of the data fields of the CAN message (instead of the sizes of the respective CAN messages).

The gateway control message 444 can be used to control the NICs, such as NICs 312, 314, 316, and 318, and ECU gateways 220 (e.g., 220a, 220b, 220c, and 220d), in combination or the like. For example, the ECU gateway D 220d may receive an instruction from the cloud 210 for software reset or upgrade. The ECU gateway D 220d can accordingly generate an ECU gateway control message 440 and broadcast it throughout the network. The gateway control message 440 may cause the receiving NICs and other CAN devices to be placed in a listen only state where the receiving NICs and other CAN devices will not send out messages.

### Examples of a CAN Message

Data in the UDP message 430 may be CAN messages, although other types of data are also possible. A CAN message may include an identifier (ID) field 462, a length field 464, a data field 466, and a CRC field 468.

The identifier (ID) field 462 may be an arbitration ID which identifies the message and indicates the message's priority. The arbitration ID may vary in length depending on the format of the CAN frame. For example, the arbitration ID may be 11-bit or 29-bit. In some embodiments, a certain number of bits are reserved for indicating message priorities. For example, a low priority message can have an upper nibble “4” while a high priority message can have an upper nibble “2”.

The CAN message 460 can also include a data length field 464 indicating the number of bytes the data field contains. The data field 466 includes 0 to 8 bytes of data. The data can include CAN signals. Because the CAN signals are in binary and the data field can have a maximum of 8 bytes of data, each CAN message can include up to 64 individual signals.

The CAN message 460 can further include a CRC field 468 for error detection. The CRC can include 15-bit CRC check code and 1 recessive delimiter bit.

As described with reference to data in the UDP message, the value in the ID field 462 and the value in the length field 464 may be part of the TOC 442 entries. For example, when a NIC receives the gateway control message 444 and message A 446 via CAN buses, the NIC can parse the frame of the gateway control message 444 and the frame of the message A 446 to extract the values from the ID field 462 and the length field 464 of the two messages. Assuming the NIC packaged the gateway control message 444 to be in front of the message A 446, the TOC 442 may put the ID 462 and length 464 pair for the gateway control message 444 to be before the ID and length pair for the message A 446.

In some embodiments, the NIC can extract a portion of the values of ID field 462 and incorporate the extracted portion into the TOC. For example, the NIC may put only the portion that identifies the message inside the TOC but not the priority information.

Because a NIC can continuously receive CAN messages, the NIC can dynamically append new messages to the end of the data field 440, until it reaches a certain limit (such as the maximum size of the UDP message). The entries and the size of the TOC 442 may also be updated in accordance with new messages added to the data field 440. Furthermore, the NIC can update the length field 436 of the UDP message 430 to reflect the correct length of the data field 440.

While the CAN message 460 is incorporated into the data field of the UDP message 430 as message A 446, the message A 446 may retain the ID field 462 and the length field 464 (shown in the dotted line in FIG. 4) together with the data field 466 and the CRC field 468. However, in some embodiments, the CAN message 460 may be split up into two parts. The first part includes the ID field 462 and the length field 464 while the second part includes the data field 466 and the CRC field 468. Accordingly, the TOC 442 may include the ID 462 and length field 464 while the message A 446 includes the data field 466 and the CRC field 468.

Although the examples in FIG. 4 show that the gateway control message 444 is in the same UDP packet as other CAN messages, these examples are not limiting. In some implementations, the gateway control message 444 may be in a separate UDP packet.

### Examples of Extracting a Relevant CAN Message

As described with reference to FIGS. 1, 2, and 3, once a NIC receives the data packet 400, the NIC can parse through the data packet 400 and deliver relevant CAN messages to a CAN device in its vehicle operating subsystems. For example, the NIC can first parse through the header of the Ethernet Frame 410 and identify whether the destination address 414 is associated with the NIC itself or another NIC. If the destination address 414 is associated with another NIC, the NIC may act as a router and forward the packet to the other NIC.

If the destination address 414 is associated with the NIC itself, the NIC can further parse through the header of the UDP message to further determine whether there are relevant messages in it. For example, the NIC can look at destination ports and see whether the destination ports are associated with the ECUs controlled by the NIC. If the NIC finds that the destination ports are not associated with the ECUs controlled by the NIC itself, the NIC may forward the UDP message to its proper destinations, such as to another NIC, or ignore or discard the message. If the NIC finds that the destination ports are within its subsystem, it may further parse the TOC in the data field and determine which message should be forwarded to which ECU. For example, the NIC can extract the identifier from the TOC and look up the identifier in a database file to obtain more information on the message. As an example, the NIC can look up the identifier in a dbc file and find information associated with the message such as the channel name, location and size of the channel within a given message, data type, range, scaling and unit string, comments, and so on. These data can be used to translate values in the CAN message. The NIC can use the information found in the database file as well as the translated values for deciding whether to forward a message to a CAN device. In some implementations, the NIC can directly look up the identifier in the dbc file without analyzing whether the destination ports are relevant to its sub system(s).

If the NIC decides that a message in the UDP's data field is relevant, the NIC can calculate an offset using the TOC to pinpoint the starting point of the message. For example, assuming: (1) message A 446 is the relevant message; (2) the size of message A 446 is 2 bytes; (3) the TOC includes gateway control message 444 before the message A 446; and (4) the gateway control message 444 is 3 bytes, then the starting point of the message A 446 is the size of the TOC plus 3 bytes. The end point of the message A 446 is the size of the TOC plus 3 bytes and plus 2 bytes.

The size of the TOC may be calculated using various ways. For example, the NIC can calculate the size of the TOC using the value of the length 436 in the UDP message 430. The NIC can subtract the length of the header from the length of the UDP message and get the length of the data field. The NIC can further add the size of all messages in the data field 440 by reading through the TOC 442. The NIC can then subtract the size of all messages from the length of the data field and get the length of the TOC 442. In some embodiments, the TOC along with other CAN messages are wrapped in an IP packet (such as an IPv4 packet) which is further incorporated into the UDP data field. The NIC can calculate the size of the TOC by subtracting the header of the IPv4 packet from the length of UDP data field 440 or from the length of the IP packet.

Once the NIC determines the starting point and the end point of the message, the NIC can extract the bytes inbetween the starting point and the end point. The NIC can further put the bytes on to a CAN bus and pass it to the appropriate destination CAN device.

The foregoing description and claims may refer to elements or features as being “connected” or “coupled” together. As used herein, unless expressly stated otherwise, “connected” means that one element/feature is directly or indirectly connected to another element/feature, and not necessarily mechanically. Likewise, unless expressly stated otherwise, “coupled” means that one element/feature is directly or indirectly coupled to another element/feature, and not necessarily mechanically. Thus, although the various schematics shown in the Figures depict example arrangements of elements and components, additional intervening elements, devices, features, or components may be present in an actual embodiment (assuming that the functionality of the depicted circuits is not adversely affected).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules, and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The foregoing description details certain embodiments of the systems, devices, and methods disclosed herein. It will be appreciated, however, that no matter how detailed the foregoing appears in text, the devices and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated. The scope of the disclosure should therefore be construed in accordance with the appended claims and any equivalents thereof.

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that the examples may be described as a process. Although the operations may be described as a sequential process, many of the operations can be performed in parallel, or concurrently, and the process can be repeated. In addition, the order of the operations may be rearranged. A process is terminated when its operations are completed. A process may correspond to a method, a function, a procedure, a subroutine, a subprogram, etc.

The previous description of the disclosed implementations is provided to enable any person skilled in the art to make or use the present disclosed process and system. Various modifications to these implementations will be readily apparent to those skilled in the art, and the generic principles defined herein may be applied to other implementations without departing from the spirit or scope of the disclosed process and system. Thus, the present disclosed process and system is not intended to be limited to the implementations shown herein but is to be accorded the widest scope consistent with the principles and novel features disclosed herein.

What is claimed is:

1. A vehicle comprises:
a plurality of vehicle operating subsystems;
a first plurality of electronic control units (ECUs) communicatively coupled to a first network communication bus associated with a first subset of the plurality of vehicle operating subsystems, wherein the first plurality of ECUs is configured to communicate over the first network communication bus with messages formatted according to a first network protocol;
a second plurality of ECUs communicatively coupled to a second network communication bus associated with a second subset of the plurality of vehicle operating subsystems, wherein the second plurality of ECUs is configured to communicate over the second network communication bus with messages formatted according to the first network protocol;
a first network interface communicatively coupled to the first network communication bus;
a second network interface communicatively coupled to the second network communication bus;
the first network interface and the second network interface are communicatively coupled to a third network communication bus, wherein the first network interface and the second network interface are configured to communicate over the third network communication bus with messages formatted according to a second network protocol;
wherein the first network interface is configured to:
receive first messages from the first plurality of ECUs via the first network communication bus;
incorporate the first messages into a packet formatted according to the second network protocol; and
send the packet to the plurality of vehicle operating subsystems; and
wherein the second network interface is configured to:
receive the packet from the third network communication bus;
parse the packet to extract second messages with addresses associated with the second plurality of ECUs;
reformat the second messages according to the first network protocol; and
deliver the second messages to the second plurality of ECUs via the second network communication bus.

2. The vehicle of claim 1, wherein the first network communication bus and the second network communication bus comprise buses for controller area networks (CAN) and wherein the third network communication bus comprises a bus for an Ethernet network.

3. The vehicle of claim 2, wherein the first messages and the second messages are CAN signals and the first network protocol is a CAN protocol.

4. The vehicle of claim 2, wherein the second network protocol is a user datagram protocol (UDP).

5. The vehicle of claim 4, wherein the packet comprises a table of contents (TOC) which comprises addresses and lengths of the first messages.

6. The vehicle of claim 5, wherein to parse the packet to extract second messages with addresses associated with the second plurality of ECUs, the second network interface is configured to:
parse through the TOC; and
identify an address and a position of a message of the second messages based on the TOC.

7. The vehicle of claim 6, wherein to identify the position of the message, the second network interface is configured to:
identify one or more messages preceding the message in the packet; and
using the TOC, calculate a start position of the message based on lengths of the one or more messages.

8. The vehicle of claim 1, wherein the second messages comprise a subset of the first messages.

9. The vehicle of claim 1, wherein the packet is encrypted.

10. The vehicle of claim 1, wherein the packet includes a control message for controlling at least one of: the first network interface or the second network interface.

11. A method for communication among a plurality of vehicle operating subsystems, the method comprising:
establishing first communications among a first plurality of electronic control units (ECUs) in a vehicle and between the first plurality of ECUs and a first network interface, wherein the first communications are via a first network communication bus associated with a first subset of the plurality of vehicle operating subsystems and the first plurality of ECUs communicates over the first network communication bus with messages formatted according to a first network protocol;
establishing second communications among a second plurality of electronic control units (ECUs) in the vehicle and between the second plurality of ECUs and a second network interface, wherein the second communications are via a second network communication bus associated with a second subset of the plurality of vehicle operating subsystems and the second plurality of ECUs communicates over the second network communication bus with messages formatted according to the first network protocol;
establishing third communications between a first network interface and a second network interface via a third network communication bus with messages formatted according to a second network protocol;
receiving, by the first network interface, first messages from the first plurality of ECUs via the first network communication bus;
incorporating, by the first network interface, the first messages into a packet formatted according to the second network protocol; and
sending, by the first network interface, the packet to the plurality of vehicle operating subsystems; and
receiving, by the second network interface, the packet from the third network communication bus;
parsing, by the second network interface, the packet to extract second messages with addresses associated with the second plurality of ECUs;
reformatting, by the second network interface, the second messages according to the first network protocol; and
delivering, by the second network interface, the second messages to the second plurality of ECUs via the second network communication bus.

12. The method of claim 11, wherein the first network communication bus and the second network communication bus comprise buses for controller area networks (CAN) and wherein the third network communication bus comprises a bus for an Ethernet network.

13. The method of claim 12, wherein the first messages and the second messages are CAN signals and the first network protocol is a CAN protocol.

14. The method of claim 12, wherein the network second protocol is a user datagram protocol (UDP).

15. The method of claim 14, wherein the packet comprises a table of contents (TOC) which comprises addresses and lengths of the first messages.

16. The method of claim 15, wherein parsing the packet to extract second messages with addresses associated with the second plurality of ECUs comprises:
parsing through the TOC; and
identifying an address and a position of the message of the second messages based on the TOC.

17. The method of claim 16, wherein identifying the position of the message comprises:
identifying one or more messages preceding the message in the packet; and
using the table of contents, calculating a start position of the message based on lengths of the one or more messages.

18. The method of claim 11, wherein the second messages comprise a subset of the first messages.

19. The method of claim 11, wherein the packet is encrypted.

20. The method of claim 11, wherein the packet comprises a control message for controlling at least one of: the first network interface or the second network interface.
